(19) United States
(12) Patent Application Publication
(10) Pub. No.: US 2004/0170013 A1
(43) Pub. Date: Sep. 2, 2004

(54) Light emitting diode address number sign

(76) Inventor: Vernon Bradford Smythe, Los Alamitos, CA (US)

Correspondence Address: VERNON B. SMYTHE, 5001 LAMPSON AVE., LOS ALAMITOS, CA, 90720, US

(21) Appl. No.: 10/376,555

(22) Filed: Feb. 27, 2003

(51) Int. Cl. F21L 4/02

(52) U.S. Cl. 362/184; 362/812; 362/252

(57) ABSTRACT

The invention is titled Light Emitting Diode Address Number Sign and is a new concept for the illumination of house or building numbers for easy recognition at night. The new invention utilizes battery powered light emitting diodes forming individual numbers which, when combined in the proper sequence in a frame, provide the whole number designating the street number of the house or building. This new invention employs a new concept encompassing the manufacture and assembly of pre-wired number modules ready for insertion into a pre-wired frame. The numbers in the sign are available in a choice of colors; white, yellow, red and green.

The Light Emitting Diode Address Number Sign is a new invention designed for the purpose of address identification at night. The numbers in the sign which make up the address are individual number modules, each module containing light emitting diodes fashioned in the form of a number. The combination of the individual number modules make up the lighted address.

The light emitting diodes in the sign are powered by a built-in battery or batteries which in turn are recharged during the daylight hours by a small solar panel. This combination of battery and solar power eliminates the need for the hard wiring of the lighted sign to the power source in the house or building which constitutes a significant safety feature as well as an important energy conservation feature.

### BACKGROUND OF THE INVENTION

This invention is in the category of illuminated signs but differs from the ordinary lighted sign. This invention uses electric battery powered light emitting diodes to form the address numbers rather than painted numbers on glass or plastic illuminated from behind by incandescent lamps wired to the building interior current.

The old system of illuminated address number signs lighted by an incandescent bulb and mounted on the outside of the premises are wired to the electrical power in the home or building. As the old style sign wears and becomes weathered, it becomes difficult to read. The glass or plastic weathers and becomes cloudy while the metal frame deteriorates from the weather possibly allowing the electrical connections to become a safety hazard.

This new invention corrects the problems inherent in the old system. The light emitting diodes will afford a clear sharp definition for many years and, being battery and solar powered, eliminate the hazard of hard wiring to the building current. The new invention will be mounted on the outside of the premises in complete safety offering a clear vision of the address number both night and day.

### BRIEF SUMMARY OF THE INVENTION

My new invention, the Light Emitting Diode Address Number Sign, is self contained with the address number, battery, and a solar powered battery re-charger mounted in a frame. The new sign has the distinct advantage of being easy to install. The home or building owner simply mounts the sign with mounting screws at a visible area on the front of the house or building and the sign will operate both day and night with no further wiring or maintenance. The old system of lighted sign had to be mounted outside, holes had to be drilled for the wiring, the wiring had to be run from the inside of the house through a conduit to the sign. Along with the wiring requirements, the old system of illumination required frequent replacement of bulbs. This new invention corrects these problems eliminating the need for hard wiring and eliminating the need for frequent bulb replacement.

### BRIEF DESDRIPTION OF THE DRAWINGS

FIG. 1—Drawing of the 5 number sign and the 3 number sign showing the frames with number modules installed.

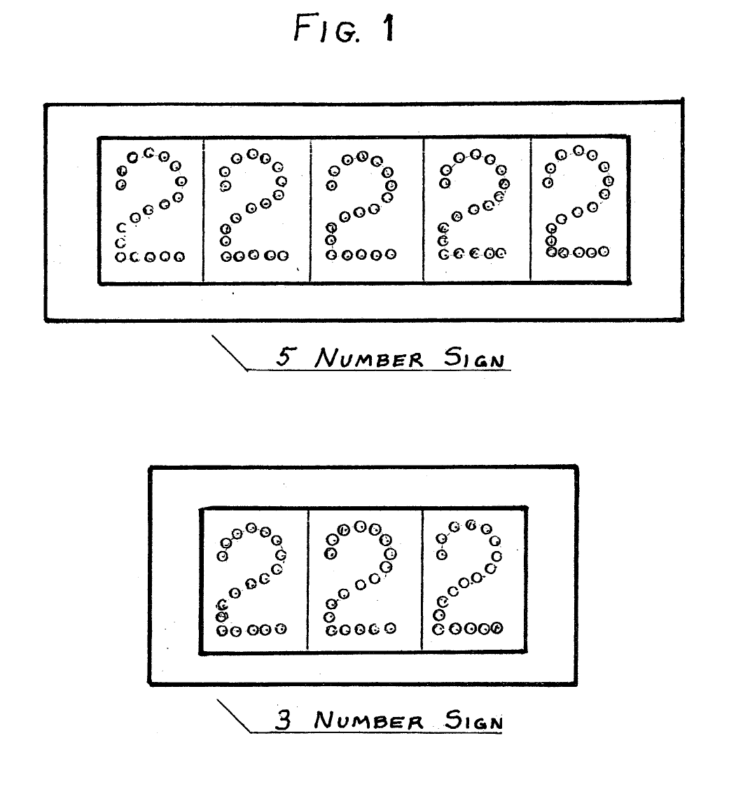

FIG. 2—Drawing showing the frames complete with the solar panel and blank modules installed.

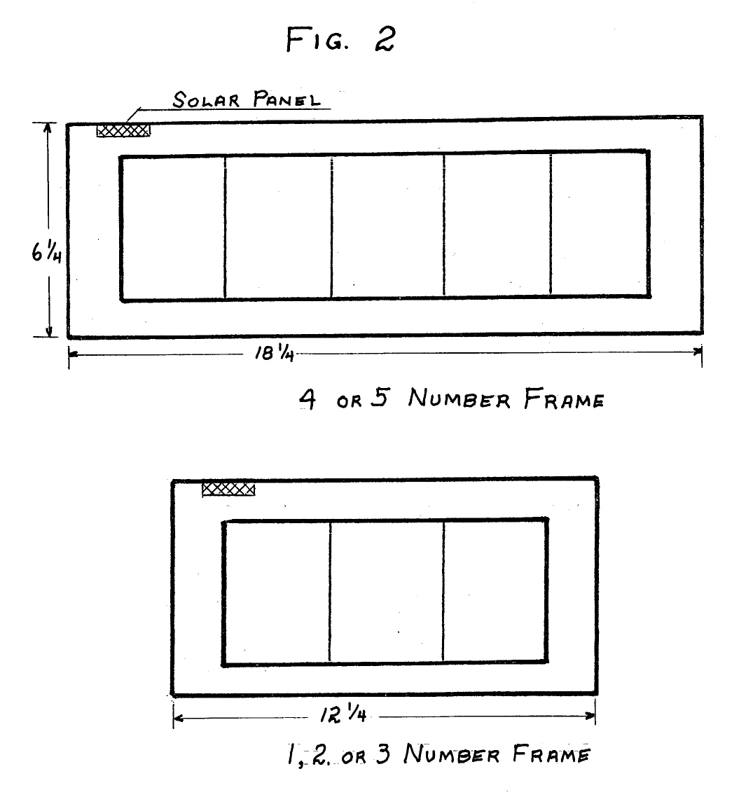

FIG. 3—Drawing of the number module showing the Light Emitting Diodes in a number array wired to the connectors.

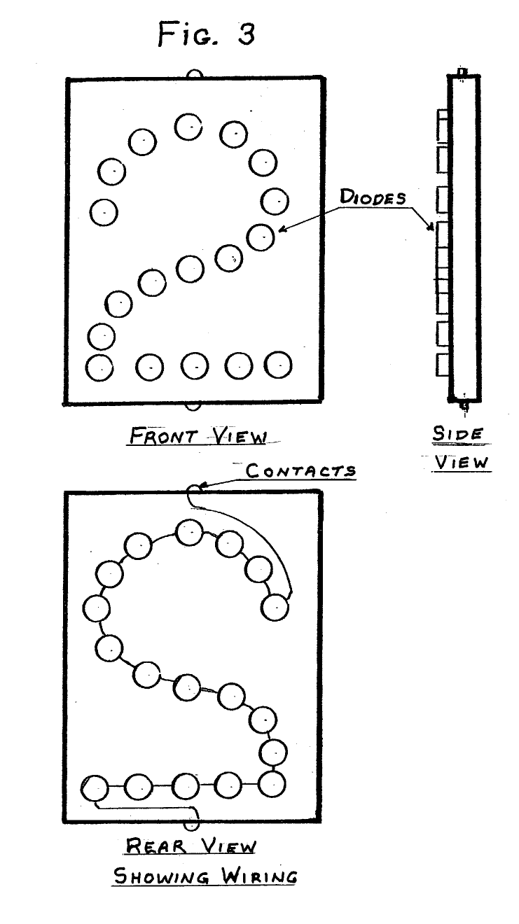

FIG. 4—Cutaway of the frame showing the solar panel, the connection contacts and a number module installed

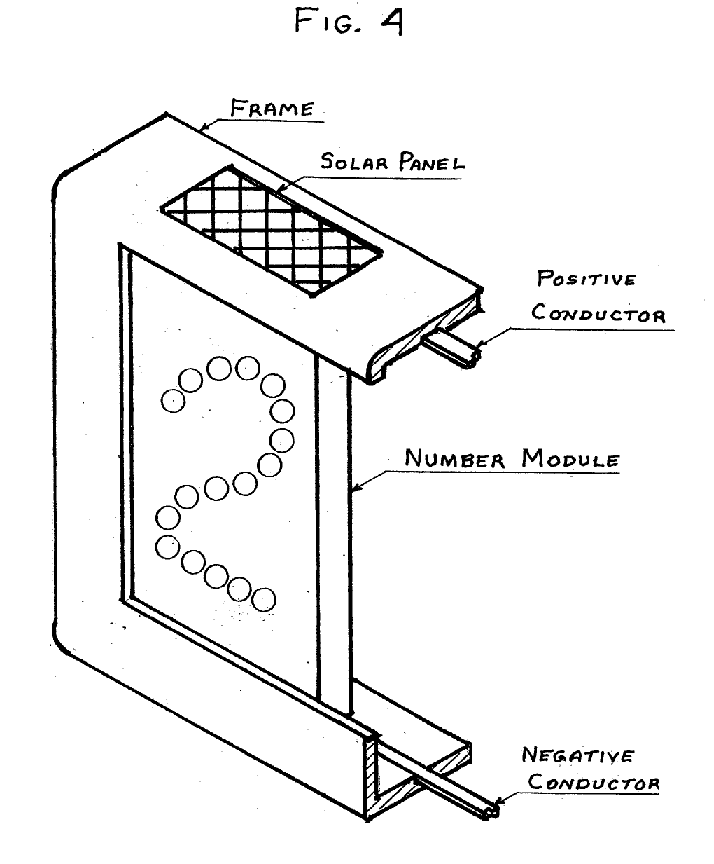

FIG. 5—Rear cutaway view of the frame showing the batteries, the solar panel, the connector contacts, both positive and negative, and the number module connections.

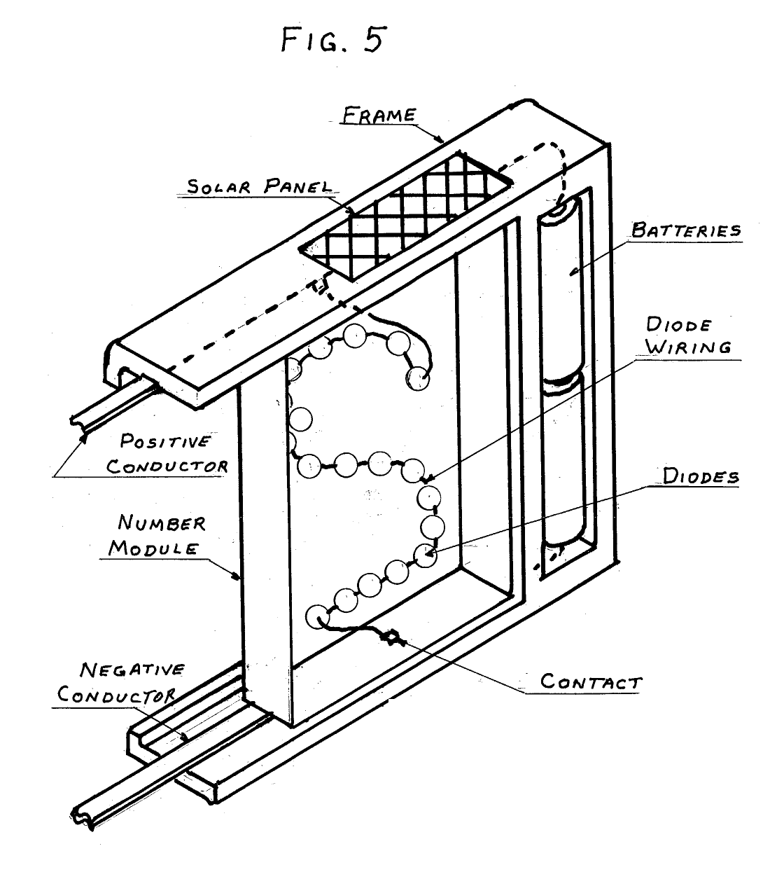

### DETAILED DESCRIPTION OF THE INVENTION

The invention, the Light Emitting Diode Address Number Sign, is a new concept for the identification of property particularly at night. Because non-illuminated address numbers are virtually impossible to see at night, this invention allows the address number to be readily discernable both day and night.

The new invention is comprised of a frame, number modules, blank modules designed to fill space not required for a number, batteries, a solar panel and internal wiring for the battery current to energize the light emitting diodes.

The frame comes in two sizes; a large size for the mounting of three, four, or five numbers to make up the street number, and a smaller size frame used for street addresses needing only one or two numbers. The frame contains a weather-proof housing for a battery or batteries as well as the solar panel. Also built into the frame are electric conductors situated to connect the battery or batteries to the individual number modules energizing the numbers for illumination. The frame is of sufficient size so that the number modules can be arranged in proper sequence and centered in the frame.

The number module is a flat rectangular shape made of plastic with the light emitting diodes permanently mounted, arranged in the form of a particular number and wired for direct connection to the electrical conductors installed in the frame. The proper number modules are installed in the frame in a sequence to form the requested street number of the property. The numbers are lighted in a desired color; white, yellow, red or green.

The blank modules are made of plastic, the same color and material as the plastic used in the number modules carrying the numbers. The blank modules are in two sizes; one is the same size as the number module and the other is one half the width of the number module. The purpose of the blank modules is to act as space fillers where needed to fill the frame and center the whole number.

The battery or batteries are mounted internally in the frame so as to be protected from the weather and are connected to the number modules by means of conductors mounted on the inside of the upper and lower edges of the frame. The small solar panel is an integral part of the frame and recharges the batteries as needed utilizing the daytime solar energy.

1. What I claim as my invention is a Light Emitting Diode Address Number Sign utilizing the application of battery operated light emitting diodes for illumination. This is a new concept of electrically illuminated street address sign, non-hard wired and weather-proof, designed for external mounting on homes or buildings.

2. What I also claim as my invention is the “number module” concept utilizing plastic modules containing individual light emitting diodes arranged in the shape of a number. The module is pre-wired for automatic connection to conductors built into the frame of the sign.

3. What I also claim as my invention is the method of assembly of the number modules in the frame. The number modules, pre-prepared as individual numbers and pre-wired, allow for the formulation of whole numbers in the frame simply by inserting the number module in the proper sequence to form the whole number of the sign. Upon insertion into the frame, the number is automatically connected to the battery power conductors.
